(19) United States
(12) Patent Application Publication
(10) Pub. No.: US 2016/0302003 A1
(43) Pub. Date: Oct. 13, 2016

(54) SENSING NON-SPEECH BODY SOUNDS

(71) Applicant: Cornell University, Ithaca, NY (US)

(72) Inventors: Tauhidur Rahman, Ithaca, NY (US); Alexander Travis Adams, Ithaca, NY (US); Tanzeem Choudhury, Ithaca, NY (US)

(21) Appl. No.: 15/094,850

(22) Filed: Apr. 8, 2016

Related U.S. Application Data
(60) Provisional application No. 62/144,793, filed on Apr. 8, 2015.

(51) Int. Cl. H04R 1/46; H04R 1/28; H04R 17/02

(52) U.S. Cl. CPC H04R 1/46; H04R 17/02; H04R 1/2876; H04R 2307/025

(57) ABSTRACT

Methods, systems, and devices are disclosed for implementing mobile sensing of non-speech sounds from a human. In one aspect, a mobile sensing system includes a microphone to capture a diverse set of body sounds while dampening external sounds and ambient noises, wherein the captured diverse set of body sounds are not speech. The mobile sensing system includes a micro-controller in communication with the microphone to perform an algorithm for signal processing and machine learning using the captured diverse set of body sounds.

### PRIORITY CLAIM AND RELATED PATENT APPLICATION

This patent document claims priority and the benefits of U.S. Provisional Application No. 62/144,793 entitled “SENSING NON-SPEECH BODY SOUNDS” and filed Apr. 8, 2015, the disclosure of which is incorporated by reference as part of the specification of this document.

### STATEMENT REGARDING FEDERALLY SPONSORED RESEARCH OR DEVELOPMENT

This invention was made with government support under grant NSF IIS#1202141 awarded by the National Science Foundation. The government has certain rights in the invention.

### TECHNICAL FIELD

This patent document relates to systems, devices, and processes that use sound capturing technologies.

### BACKGROUND

Human speech processing has been studied extensively over the last few decades. The emergence of Apple Siri, the speech recognition software on iPhones, in many ways, is a mark of success for speech recognition technology. However, there is very little research on using sensing and computing technologies for recognizing and interpreting non-speech body sounds.

### SUMMARY

Examples of implementations of the disclosed technology can provide a mobile sensing system, called BodyBeat mobile sensing system, for capturing and recognizing a diverse range of non-speech body sounds in real-life scenarios. Non-speech body sounds, such as sounds of food intake, breath, laughter, and cough contain invaluable information about our dietary behavior, respiratory physiology, and how they affect our body.

In one example aspect, a mobile sensing system embodiment includes a custom-built piezoelectric microphone and a distributed computational framework that utilizes an ARM microcontroller and an Android smartphone. The custom-built microphone is designed to capture subtle body vibrations directly from the body surface without being perturbed by external sounds. The microphone is attached to a 3D printed neckpiece with a suspension mechanism. The ARM embedded system and the Android smartphone process the acoustic signal from the microphone and identify non-speech body sounds. Results show that BodyBeat outperforms other existing solutions in capturing and recognizing different types of important non-speech body sounds.

In another aspect, a custom-made piezoelectric sensor-based microphone is able to capture a diverse set of body sounds while dampening external sounds and ambient noises.

In another aspect, a body sound classification algorithm is based on a set of discriminative acoustic features.

In another aspect, an algorithm for signal processing and machine learning are implemented on an ARM micro-controller and an Android smartphone.

In another aspect, a benchmarking of performance of a custom-made microphone against other state-of-the-art microphones, an evaluation of the performance of the body sound classification algorithm, and profiling of the system performance in terms of CPU and memory usage and power consumption are disclosed.

In another aspect, a mobile sensing system includes a microphone to capture a diverse set of body sounds while dampening external sounds and ambient noises, wherein the captured diverse set of body sounds are not speech. The mobile sensing system includes a micro-controller in communication with the microphone to perform an algorithm for signal processing and machine learning using the captured diverse set of body sounds.

The mobile sensing system can be implemented to include one or more of the following features. For example, the micro-controller can perform the algorithm to recognize physiological reactions that generate the captured sounds. The microphone can include a piezoelectric sensor-based microphone that captures body sounds conducted through the body surface. The piezoelectric sensor-based microphone can be highly sensitive to subtle body sounds and less sensitive to external ambient sounds or external noise. The microphone and the micro-controller in combination can recognize non-speech body sounds by performing a body sound classification algorithm based on a set of discriminative acoustic features of the non-speech body sounds. The micro-controller can include includes an ARM micro-controller.

In another aspect, a mobile device for sensing non-speech body sounds includes a mobile sensing system. The mobile sensing system includes a microphone to capture a diverse set of body sounds while dampening external sounds and ambient noises, wherein the captured diverse set of body sounds are not speech. The mobile sensing system includes a micro-controller in communication with the microphone to perform an algorithm for signal processing and machine learning using the captured diverse set of body sounds.

The mobile device can be implemented in various ways to include one or more of the following features. For example, the mobile device the mobile device can include a smartphone.

In another aspect, the disclosed technology can provide mobile sensing systems, devices, and methods as described and illustrated in this patent document.

The subject matter described in this patent document can be implemented in specific ways that provide one or more of the features described in this patent document.

### BRIEF DESCRIPTION OF THE DRAWINGS

FIG. 1 illustrates approximate frequency range and relative loudness of selected body sounds.

FIG. 2 is a diagram of an embodiment of a piezoelectric sensor-based microphone.

FIG. 3 illustrates an example of a frequency response test setup, used to establish the sensitivity of each microphone from 20 Hz to 16 kHz.

FIG. 4 shows a comparison of frequency responses of different microphones from 20 Hz to 16 kHz.

FIG. 5 shows an example of an external noise test setup.

FIG. 6 illustrates a comparison of different microphone's susceptibility to different type of external sounds or ambient noises.

FIG. 7 illustrates a technique for comparing different body positions (jaw, skull, and throat) for capturing different types of body sounds.

FIG. 8 illustrates (a) Microphone attached to suspension mechanism (front view), (b) Microphone attached to suspension (back view), (c) 3D printed neck band, (d) Neck band, suspension capsule, and microphone fully assembled, (e) User wearing the fully assembled system.

FIG. 9 shows examples of microphone and suspension capsules.

FIG. 10 shows examples of spectrograms of silence, speech, and non-speech body sounds.

FIG. 11 shows example scatter plots in 2D feature spaces.

FIG. 12 shows scatter plots in 2D feature spaces.

FIG. 13 shows the impact of (a) frame size (b) window size (c) total number of features on the performance of classifier.

FIG. 14 illustrates an example block diagram of BodyBeat system architecture.

FIG. 15 shows an example of the ARM Micro-Controller Unit.

FIG. 16 is an illustration for a wearable that monitors body sounds and environment.

FIG. 17 shows an example mobile sensing system to capture and analyze subtle body sounds.

FIG. 18 shows example sound profiles illustrating advantages of disclosed mobile sensing system.

FIG. 19 shows how an environment can affect our bodies.

FIG. 20 shows how much environmental context, such as air quality can change on both macro and micro level.

FIG. 21 shows example environmental sensors that can sense temperature, humidity, altitude, UV light, dust, oxygen, methane, CO₂, etc.

FIG. 22 shows an example system for remotely monitoring clinically vital sounds from multiple people in multiple locations.

FIG. 23 is a flowchart example of a method for sensing non-speech body sounds.

### DETAILED DESCRIPTION

Techniques, systems, and devices are described for implementing a mobile sensing system, called BodyBeat mobile sensing system, for capturing and recognizing a diverse range of non-speech body sounds in real-life scenarios.

Section headings are used in the present document only for improving readability, and do not in any way limit the scope of the disclosed technology.

### 1. INTRODUCTION

Non-Speech body sounds contain invaluable information about human physiological and psychological conditions. With regard to food and beverage consumption, body sounds enable us to discriminate characteristics of food and drinks. Longer term tracking of eating sounds could be very useful in dietary monitoring applications. Breathing sounds, generated by the friction caused by the air flow from our lungs through the vocal organs (e.g. trachea, larynx, etc.) to the mouth or nasal cavity, are highly indicative of the conditions of our lungs. Body sounds such as laughter and yawn are good indicators of affect. Therefore, automatic tracking these non-speech body sounds can help in early detection of negative health indicators by performing regular dietary monitoring, pulmonary function testing, and affect sensing.

In some implementations, condenser microphones can be used to capture sounds via air pressure variations. However, the condenser microphone may not be the most appropriate microphone to capture non-speech body sounds. One reason is that some non-speech body sounds such as eating and drinking sounds are very subtle and thus generate very weak air pressure variations. This makes them very difficult to be captured by condenser microphones. Second, the condenser micro-phone is very susceptible to external sounds and ambient noises. As a result, the quality of body sounds captured by condenser microphones decreases significantly in real-world settings.

Disclosed are the design, implementation, and evaluation of the BodyBeat mobile sensing system, for capturing and recognizing a diverse range of non-speech body sounds in real-life scenarios. The mobile sensing system is capable of capturing a diverse set of non-speech body sounds and recognizing physiological reactions that generate these sounds. BodyBeat is built on top of a novel piezoelectric sensor-based microphone that captures body sounds conducted through the body surface. However, it may be possible to use a carefully designed, non-piezoelectric sensor based microphone, for example, a capacitive microphone, a microelectromechanical (MEMS) based microphone, an accelerator-based microphone or an electromagnetic microphone, in implementations of technology described herein. The microphone is preferably designed to be highly sensitive to subtle body sounds and less sensitive to external ambient sounds or external noise. This way, the microphone picks up sound signals by being in direct contact with a subject and filters out receiving sound signals through air, thereby improving fidelity of received signals and also allaying any privacy concerns of people around a subject. To recognize these non-speech body sounds, a set of discriminative acoustic features were carefully selected and a body sound classification algorithm was developed. Given the computational complexity of this algorithm and the resource limitation of the smartphone, the whole computational framework was partitioned and a distributed computing system was implemented that includes an ARM micro-controller and an Android smartphone. To evaluate the effectiveness of BodyBeat, the custom-made microphone, the classification algorithm, and the distributed computing system were tested using non-speech body sounds collected from 14 participants. Specifically, the patent document describes: (1) design and implementation of a custom-made piezoelectric sensor-based microphone that is able to capture a diverse set of body sounds while dampening external sounds and ambient noises; (2) development of a body sound classification algorithm based on a set of discriminative acoustic features; (3) implementation of the signal processing and machine learning algorithm on an ARM micro-controller and an Android smartphone; and (4) benchmarking of the performance of the disclosed custom-made microphone against other state-of-the-art microphones, evaluating the performance of the body sound classification algorithm, and profiling the system performance in terms of CPU and memory usage and power consumption.

The patent document is organized as follows. Section 2 outlines examples of challenges and design considerations of the development of the body sound sensing system. Section 3 presents the design and test results of some embodiments of a custom-made piezoelectric sensor-based microphone. In Section 4, the feature selection and classification algorithms for recognizing a diverse set of body sounds are described. In Section 5 explains in details the implementation of the computational framework on the ARM micro-controller and the Android smart-phone. The potential applications of BodyBeat are described in Section 6. A brief review on some of the existing work is described in Section 7 and a conclusion is provided in Section 8.

### 2. DESIGN CONSIDERATIONS

There are various challenges of capturing and recognizing non-speech body sounds. The design of the BodyBeat mobile sensing system addresses these challenges. The detailed design is described in Section 3 and 4.

### 2.1 Capturing Non-Speech Body Sounds

In the context of mobile sensing, the built-in microphone is the most widely used sensor for detecting acoustic events. However, the mobile phone microphone (typically an electret or condenser microphone) is often specifically designed for the purpose of voice communication and thus the frequency band is optimized for speech. Non-speech body sounds are generated by complex physiological processes inside the human body. After body sounds is produced inside our body, the energy of the body sounds decreases significantly by the time they reach the body surface. Therefore, non-speech body sounds are in general barely audible. Based on the frequency differences between voice and body sounds, the mobile phone microphone is not the best acoustic sensor for capturing non-speech body sounds. In building the BodyBeat microphone, the following design specifications are considered:

1. The microphone should capture a wide array of subtle body sounds lying in different portion of the frequency spectra.

2. The microphone should be robust against any external sound or ambient noise.

3. The microphone should have mechanisms compensating friction noise due to user's body movement.

The first two specifications are essential for continuous capture of different body sounds with a high signal-to-noise ratio. In the third specification, the mechanical movement of the body may generate noise due to the friction between body surface and the microphone, which may render captured body sounds uninterpretable. Therefore, the system should include a mechanism with the microphone to avoid the generation of the friction noise due to users' body movement.

A new microphone, BodyBeat, is disclosed that captures a wide range of non-speech body sounds. Specifically, BodyBeat adopts a custom-built piezo-electric sensor to capture these sounds. Since it's worn around the user's throat, the bone conduction sensor is very sensitive to the vibration caused by non-speech body sounds in the frequency spectrum of 20 Hz to 1300 Hz. In addition, BodyBeat is also customized to dampen any external sound or noise from the ambient environment. In this manner, most of the features of non-speech body sounds are preserved and captured without being skewed by external sounds. In Section 3, the custom-built microphone is described and its superior performance is demonstrated in capturing non-speech body sounds, compared to a range of other state-of-the art microphones. In some embodiments, the microphone may be designed to capture sound signals at even lower frequencies, e.g., from 1 Hz to 1300 Hz.

### 2.2 Recognizing Non-Speech Body Sounds

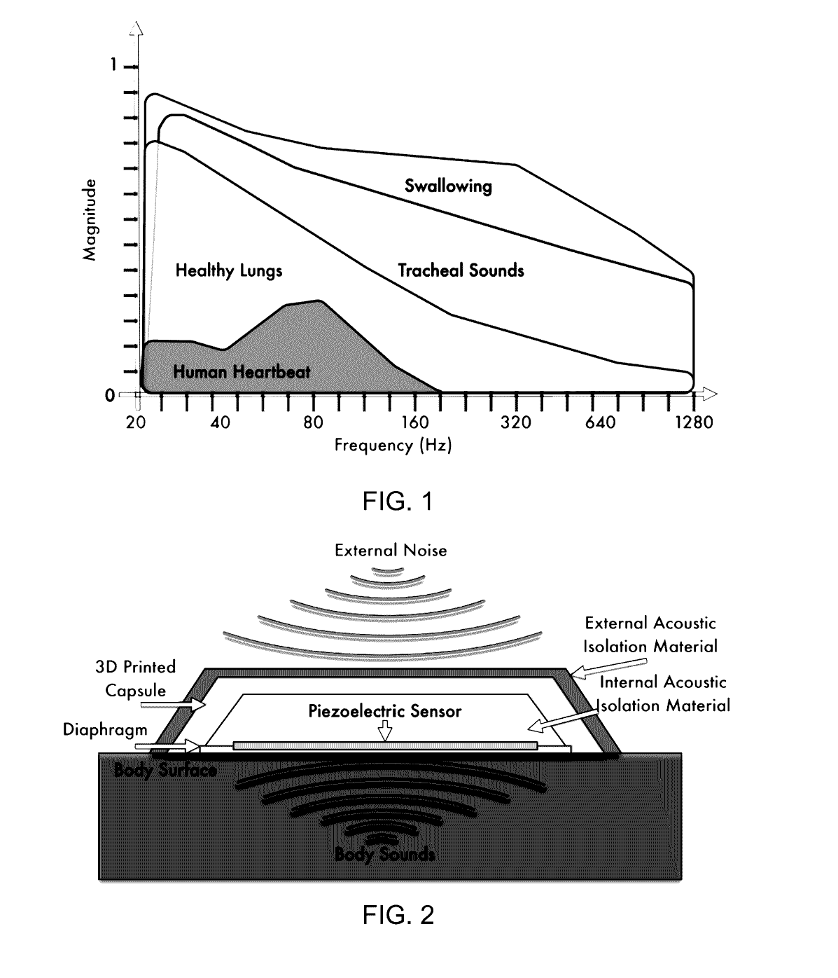

Compared to speech sounds, non-speech body sounds have distinct frequency spectrum. Specifically, the frequencies of speech sounds range from 300 Hz to 3500 Hz. In comparison, non-speech body sounds are located within the lower region of the frequency spectrum, ranging from 20 Hz to 1300 Hz. As an example, FIG. 1 illustrates the frequency spectrum of four non-speech body sounds. As shown, the human heartbeat is one of the more subtle body sounds with a low magnitude from 20 Hz to 200 Hz. Breathing sounds (ranging from 20 Hz to 1300 Hz) are much louder in the 20 Hz to 200 Hz range but have a large loss in magnitude as the frequency range increases. The unique nature of the body sound's power spectra suggests that spectral features such as power in different filter banks or spectral centroid, spectral variance, spectral entropy might contain valuable information to discriminate among body sounds. Moreover, the concentration of the body sound in the low frequencies warrants higher attention to the minute changes in the low frequencies, in other words higher frequency resolution in the low frequencies. Also, logarithmic filter banks having center frequencies and bandwidth increase logarithmically could be used.

Disclosed technology includes designing and extracting a variety of acoustic and statistical features with the objective of comprehensively describing the characteristics of body sounds. The performance of the feature pool is critically examined and a subset of them is selected, which are the best in modeling body sounds. An inference algorithm is trained and optimize for different parameters.

TABLE 1
Introducing all the microphones considered for recording subtle body sounds

| Sensor ID | Origin | Type of Mic Sensor | Diaphragm Material | Using Stethoscope Head | Reference |
|---|---|---|---|---|---|
| M1 | Custom-made | brass piezo | latex | no | — |
| M2 | Custom-made | brass piezo | silicon | no | — |
| M3 | Custom-made | film piezo | latex | no | — |
| M4 | Custom-made | brass piezo | latex | yes | — |
| M5 | Custom-made | condenser | plastic | yes | BodyScope |
| M6 | Off-the-shelf | unknown | unknown | no | Invisio |
| M7 | Off-the-shelf | unknown | unknown | no | Temcom |

### 2.3 Resource Limitations and Privacy Issues

In designing BodyBeat, the resource requirements of various computational frameworks are considered and opted for techniques that were capable of running analog to digital conversion of the audio signal; acoustic feature extraction; and classification of body sounds in real-time. Implementing the algorithm entirely in the Android smartphone would be very computationally expensive, and it would cause an unnecessary battery drain. In contrast, another extreme implementation approach would be transferring all the data to a web-based service that classifies the raw (or semi-processed audio signal) to different body sounds. This approach requires good internet connectivity to transfer large amounts of data. Therefore, we optimized our approach by implementing our algorithm in two different platforms: an ARM micro-controller and an Android smartphone.

The audio codec and portions of the feature extraction were implemented on the ARM micro-controller. The ARM unit also employed a frame admission control using some acoustic features, which filtered unnecessary frames that contained no body sounds of interest. If the ARM unit finds a frame containing a specified body sound, it sends the frequency spectrum of the current frame to the Android phone via Bluetooth. We employed a fast and computationally efficient fix-point signal processing algorithm in the ARM unit. Unlike a web-based implementation, this distributed implementation infers body sounds in real-time, which will allow for real-time intervention applications in the future.

We also take the privacy issues into consideration in the design of BodyBeat. To safeguard privacy, BodyBeat filters out the user's raw speech data via an admission control mechanism. In addition, the BodyBeat microphone is specifically designed to be robust against external sounds and thus any speech from other conversation partners is not captured.

### 3. MICROPHONE DESIGN AND EVALUATION

In this section, we present the design of our BodyBeat microphone for capturing non-speech body sounds. We compare the performance of a set of seven microphones based on the design requirements presented in Section 2.1.

### 3.1 Microphone Design

FIG. 2 illustrates the architecture of our custom-built piezo-electric sensor-based microphone. The microphone was built around a piezoelectric sensor and a 3D printed capsule. This capsule is made with a 3D printer using Polylactic Acid (PLA) filament. Alternatively or additionally, in various embodiments, the capsule could be made using an injection molding process and may be made up of other polymer material or suitable thermoplastics such as Acrylonitrile butadiene styrene (ABS) or Polyoxymethylene (POM). The piezoelectric sensor may be a bronze-based piezoelectric sensor. The capsule was then filled with a soft silicone or another material with shore hardness of 10 or generally in the range of 10 OO to 20 A, as internal acoustic isolation material. The shore hardness numbers used in this document are represented using a well-known shore hardness scale that uses shore OO, shore A and shore B scales for measuring increasingly harder materials. The piezoelectric sensor was then placed in the capsule with the back of the sensor lying on top of the soft silicone filling to capture the subtle body sound vibrations. After the silicone filling cured, the exposed front of the piezoelectric sensor was covered with a thin diaphragm (˜0.001 mm, or 0.002 mm or lower), made of either silicone or a piece of latex. Lastly, the exterior of the capsule was covered using external acoustic isolation material, which is a hard, dense, brushable silicone (shore hardness of 50, or in the range 40 A to 80 A). One advantageous feature of the silicon rubber is that it is highly absorbent of ambient noise from the air. The internal and external acoustic isolation material (respectively the soft silicone layers inside the capsule and hard silicone layer outside the capsule) act as acoustic isolators, which helps to reduce external noise. In addition, the soft silicone inside the capsule helps the piezoelectric sensor to absorb the surface vibrations without damping the piezoelectric transduction too much. For this design, selecting the right diaphragm material is crucial. A material that has very similar acoustic properties of muscle and skin will maximize the signal transfer to the microphone. Moreover, as the diaphragm is placed on users' skin, we considered inert materials so as to not irritate users' skin. In some embodiments, biocompatible material like silicone rubber membrane may be used instead of a latex membrane considering long term usability and users' comfort.

### 3.2 Performance Benchmarking

In this work, we built four different types of microphones (M1, M2, M3, and M4) based on the same architecture shown in FIG. 2. We varied two variables (type of piezo and diaphragm material) to build these four microphones (M1, M2, M3, and M4). In addition, we duplicated the microphone proposed in Yatani, K., and Truong, K. Bodyscope: A wearable acoustic sensor for activity recognition. UbiComp '12 (2012), 341-350. It (M5) is made with a small condenser microphone attached to a stethoscope head. We also considered two additional state of the art commercial bone conduction microphones: M6 of Invisio M3 and M7 from Temco Japan Co., LTD. Instead of capturing sound directly from the air, both M6 and M7 are designed to pick up sound conducted through bone from direct body contact. They also have been extensively used for speech communication under highly noisy environment for army, law enforcement agencies, fire rescuers etc. We ran two tests using the seven microphones listed in table 1. Firstly, a frequency response test is run to compare the sensitivity of different microphones. Then we run an external noise test to compare the susceptibility of different microphones. Based on these two test, a microphone that is highly sensitive to the body sound and less susceptible to external sound is selected. A microphone position test is run to select the optimal head location to attach the BodyBeat microphone to capture a wide range of body sounds

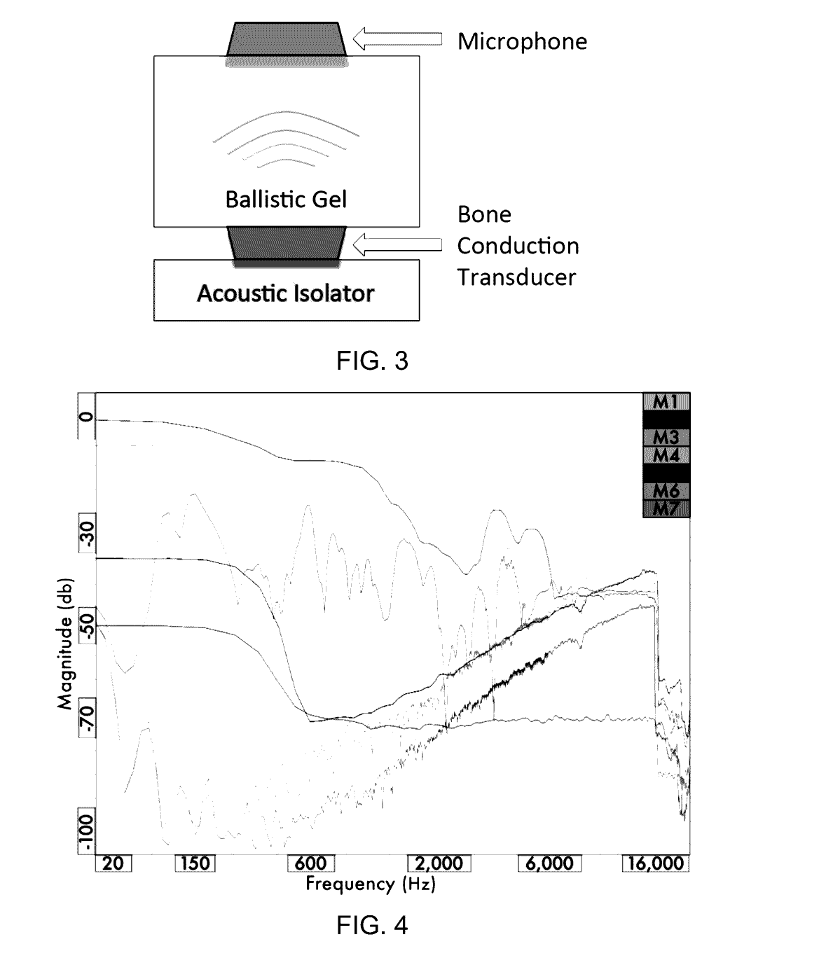

We used a bone conducting transducer as our output device and created a sweeping tone that changed its frequency from 20 Hz to 16,000 Hz. An 8×8×5.5 centimeter block of ballistic gel was placed on top of the bone conducting transducer. The ballistic gel block is a standard proxy of human flesh or muscle because of its similarity in acoustic properties (e.g. speed of sound, density, etc.). We firmly attached different microphones to the other side of the ballistic gel block. FIG. 3 shows the setup of the frequency response test. We ran this experiment for all the seven different microphones listed in Table 1.

FIG. 4 shows the frequency responses of different microphones. Our results indicate that with a constant gain, M1, M2, and M3 are the most sensitive below 700 Hz. M3 maintained the flattest response, but lower than that of M1's and M2's. The significant peaks and drop-offs at seemingly random intervals along the frequency axis. M6 and M7 have similar response patterns. M5's response was mostly flat under 600 Hz, but it showed similar trends to M6 and M7 above 600 Hz. Above 700 Hz, M1-M5 had similar response patterns though the magnitude of M5's response was significantly lower. Unlike other microphones, we found a very irregular oscillating frequency response for M6 and M7, which is also considerably lower in the lower part of the frequency range (below 7000 Hz). One explanation of this phenomenon is that most of the off-the-shelf microphones (M6 and M7) are designed for recording speech; thus, they are not optimized for body sounds that lie in relatively lower part of the frequency spectrum. As most of our targeted non-speech body sounds are in a lower part of the frequency range, the frequency response of M2 suggests that it is the most appropriate microphone for capturing subtle body sounds.

### 3.2.2 External Noise Test

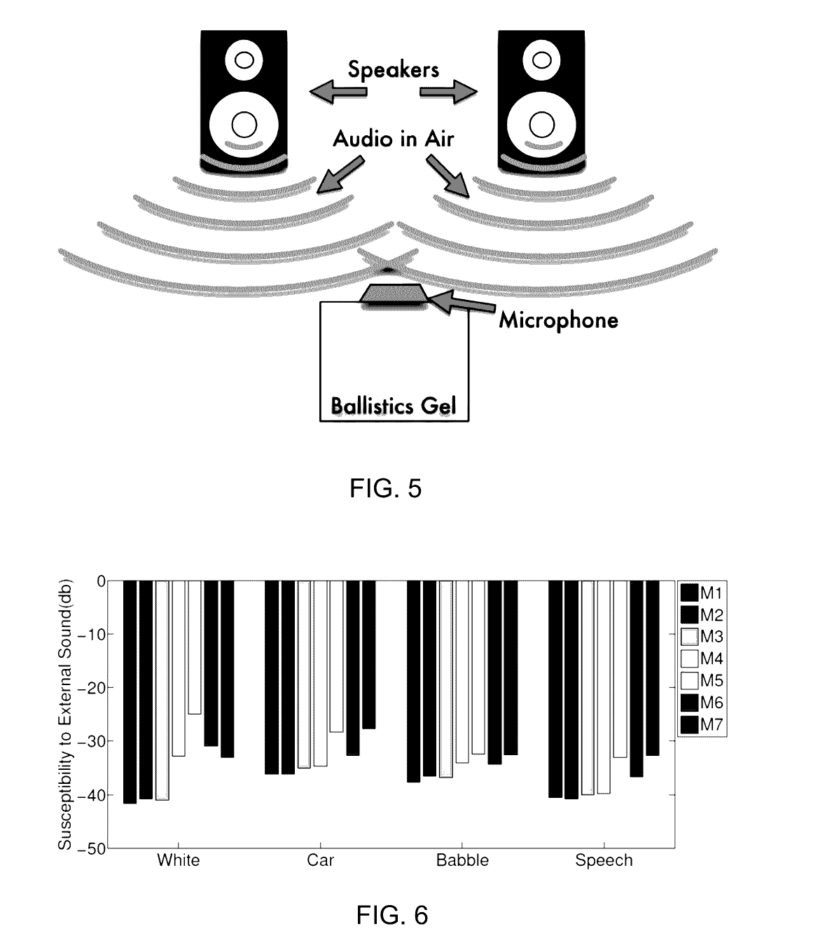

The external noise test was performed to compare the microphone's robustness against any external or ambient noise. Four prerecorded external noises were played through two speakers to recreate the scenarios in this experiment. These sounds included: white noise, social noise (recorded in a restaurant), traffic noise (recorded in an intersection of a highway), and conversational noise (recorded while another person was talking). For this test, each microphone was positioned over the ballistic gel so that the element was facing the gel and the speakers were facing the back of the microphone. The different recordings were played through the speakers (i.e., audio in air), approximately one meter above the microphone. FIG. 5 illustrates the setup of the external noise test.

We measure susceptibility (in db) using equation 1, where Power_{mic} is the power of the signal recorded by the microphone and Powerₛₚₑₐₖₑᵣ is the power emitted from the speaker. We used the standard Root Mean Square (RMS) metric to measure the power. FIG. 6 illustrates the susceptibility of different microphones under different types of external sounds. The smaller value of the susceptibility metric of the custom-built M1, M2 and M3 shows that they are more sound proof against external sounds. M5 turned out to be the least robust against external noise. The two off-the-shelf microphones (M6 and M7) were less robust against external sound than M1-M3.

$$Susceptibility = 10 * log ( \frac{{Power}_{mic}}{{Power}_{speaker}} ) \qquad Eq . ( 1 )$$

Based on the frequency response test and the external noise test, we found our custom-built microphone, M2, to be the optimal microphone. While the external noise test was better for M1 than M2, the overall frequency response of M2 was consistently higher in magnitude, up to approximately 2000 Hz. The difference in external noise was much less significant than the difference in frequency response between M1 and M2. The construction of these two microphones was identical except for one feature: the diaphragm of M1 was covered with a thin piece of latex, while the diaphragm of M2 was covered with a thin piece of silicone. This leads us to the conclusion that latex is mildly better at preventing external noise than silicone, but silicone is much better at transferring vibration below 2000 Hz than latex. Therefore, we selected M2 for the BodyBeat microphone, as it is very insensitive to external sounds and highly sensitive to any sound generated inside the body (including speech).

### 3.3 Microphone Position Test

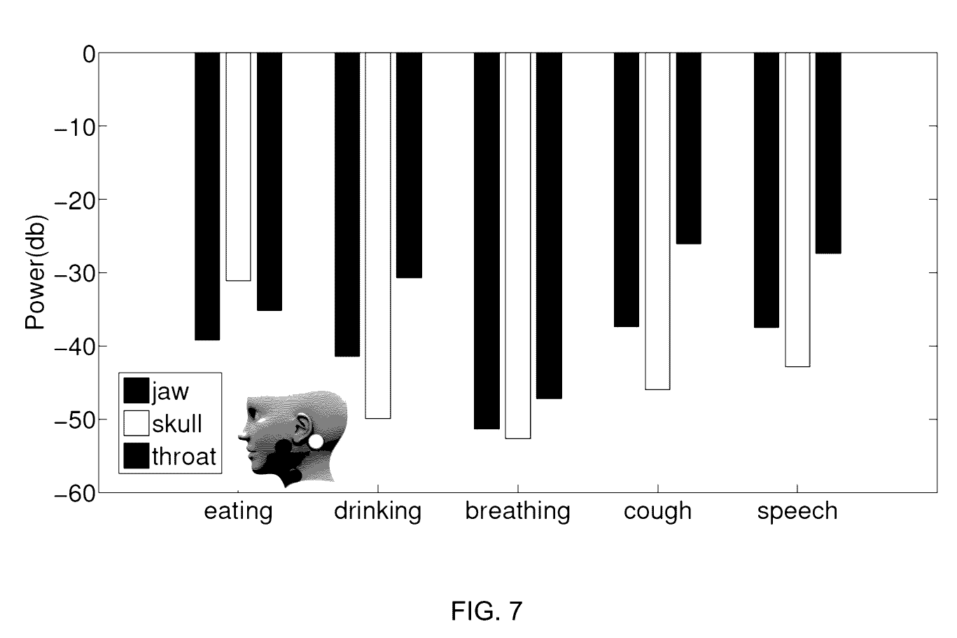

We conducted a microphone position test to find the optimal position to place the custom microphone (M2) in order to enable it to capture a wide range of body sounds. This test consisted of two parameters: the first being body position (jaw, skull, & throat) and the second being body sounds (eating, drinking, breathing, coughing, & speech). We recorded the five types of body sounds with M2 in each of the three body positions, and we then compared the power of the captured signals across different body positions. FIG. 7 illustrates the power (10 log(P) in decibel unit) of the signals captured at different body positions.

Among the three locations, the throat gives us the maximum power (db) for all types of non-vocal body sounds, except eating. The power of the captured eating sounds was similar in all three locations. However, the eating sound captured in the skull contained slightly higher power than that captured in other positions. This is likely because the eating sound can very easily propagate through the teeth and then through the jaw to the skull. Considering our goal of capturing the wide range of body sound classes, the throat is the right location for the BodyBeat microphone.

### 3.4 Neckpiece Design

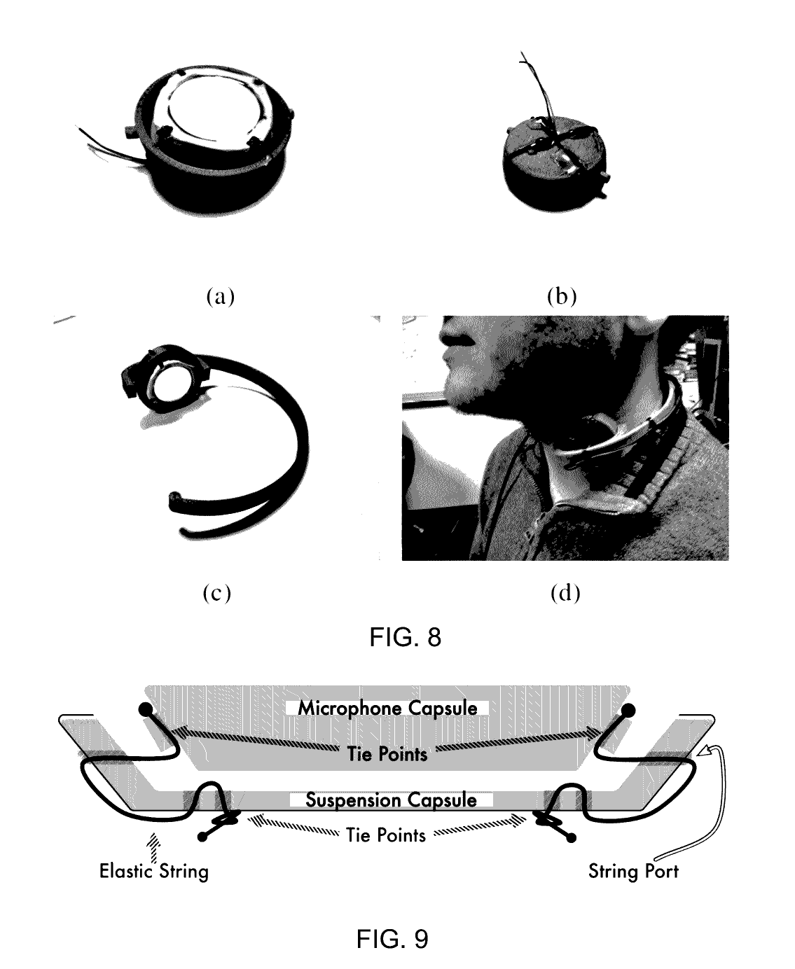

To capture a wide range of non-speech body sounds from the throat area, we designed a neckpiece to securely attach the custom-made microphone to the throat area. In order to handle users' daily interactions and maintain performance, we also considered friction noise when designing the neckpiece. Human body movements generate noise due to the friction between the silicone diaphragm and the skin. We maintained usability by adopting a suspension mechanism, which allows the microphone's position to be partially independent of the neckpiece. In other words, the microphone remains in place and firmly attached to the neckpiece even when moving, thus minimizing friction noise. FIGS. 8a and 8b illustrate the top and bottom view of the microphone attached to the suspension capsule.

The microphone is attached to the suspension capsule with four elastic strings (approximately 1 mm in diameter). The suspension allows for approximately four millimeters of movement on all sides and four millimeters of vertical movement (for a total of eight millimeters of movement on all three axes). FIG. 8c shows the 3D printed neck band. The suspension capsule is attached to the neck band by placing the two cylindrical knobs into the corresponding holes on the two small, inward pointing extensions on the neck band. The band is flexible, which allows for the capsule to be easily placed in (or taken out) and still be tightly attached to the neck band (FIG. 9). This design also allows the suspension capsule and microphone to pivot on the horizontal axis, allowing users to adjust for comfort. In FIG. 8, the current BodyBeat wearable system is still relatively big in size, which may cause some wearability issues. Iteratively, the design of BodyBeat can be improved. The BodyBeat can be integrated into promising wearable systems (such as Google Glass) to enhance wearability.

### 4. CLASSIFICATION ALGORITHM

### 4.1 Data Collection

We recruited 14 participants (5 females) with different heights to collect a wide range of body sounds. The participants are asked to wear the BodyBeat neckpiece and to adjust the position of the microphone so that it is placed beside the vocal cord. The types of body sounds and a short description of each task are listed in table 2. We also collected silence and human speech sounds. Since our primary focus is detecting non-speech body sounds, we treat silence and human speech sounds as sounds that our classification algorithm should be able to recognize them and filter them out. During data collection, all body sounds were recorded with a sampling rate of 8 kHz and a resolution of 16-bit. In total, each of our participants contributed approximately 15 minutes of recordings.

TABLE 2
A list of non-speech body sounds and other sounds collected

| Index | Non-Speech Body Sound | Description |
|---|---|---|
| 1 | Eating | Eat a crunchy cookie |
| 2 | Eating | Eat an apple |
| 3 | Eating | Eat a piece of bread |
| 4 | Eating | Eat a banana |
| 5 | Drinking | Drink water |
| 6 | Deep Breathing | Deeply breath |
| 7 | Clearing Throat | Clear your throat |
| 8 | Coughing | Cough |
| 9 | Sniffling | Sniffle |
| 10 | Laugh | Laugh aloud |
| Index | Other Sounds | Description |
| 11 | Silence | Take a moment to relax |
| 12 | Speech | Tell us about yourself |

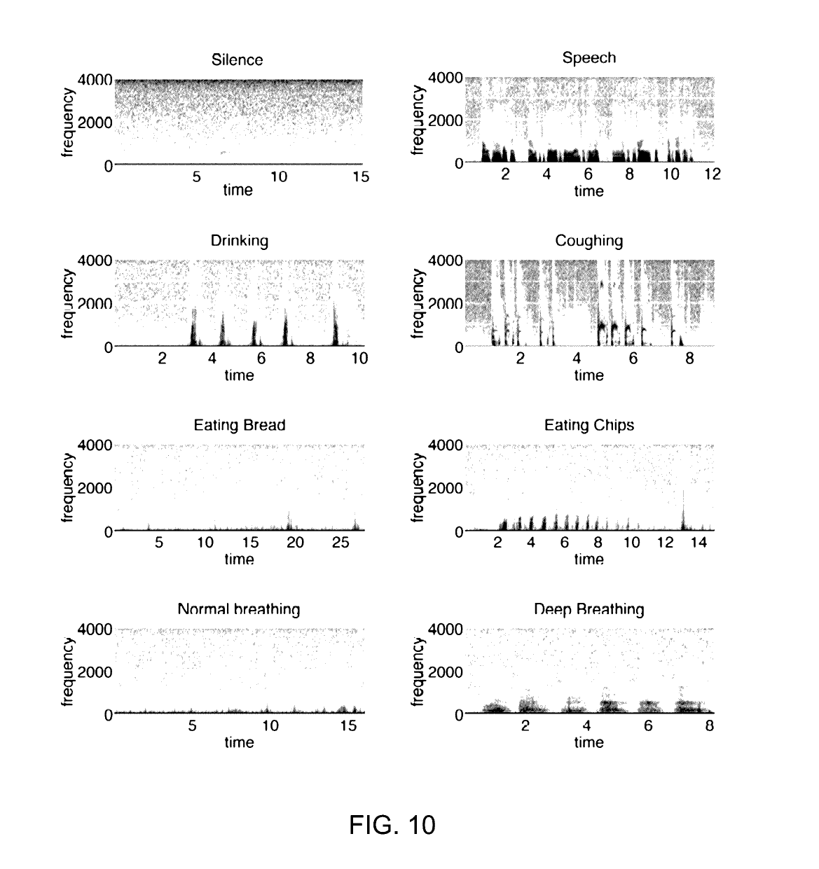

To examine the acoustic characteristics of the collected body sounds, we plot their corresponding spectrograms in FIG. 10. Spectrogram illustrates a visual representation of the frequency spectrum in a sound as it varies with time. As a comparison, the spectrograms of both silence and speech are also incorporated. As expected, silence spectrogram contains almost no energy throughout the duration of the recording. On the other hand, the spectrogram of speech contains significantly more energy due to the vibration of vocal fold during speech utterances. Among non-speech body sounds, the swallowing sound during drinking generates a distinct frequency pattern. Coughing sound generates two harmonic frequencies following a particular time varying pattern in the spectrogram. When eating crispy hard foods (like chips), chewing is much more pronounced and visible in the spectrogram than that of soft food like bread. The frequency response of deep breathing is much more powerful than that of normal breathing, although both of the breathing variants follow similar trend (in terms of changes of frequency distribution over time). Lastly, the two spectrograms of eating soft food (bread) and normal breathing (in FIG. 10) follow a very similar trend.

### 4.2 Feature Extraction

The raw audio data sampled from the microphone was first segmented into frames with uniform length and 50% overlap. The length of the segmented frame is critical for the classification procedure that follows. In this work, we considered the frame length in the range from 16 ms to 256 ms. The optimal frame length is determined empirically based on the classification performance.

To characterize body sounds, we employed a two-step feature extraction procedure. In the first step, we extract a number of acoustic features from each frame to construct frame-level features. Acoustic features for analyzing human speech have been studied extensively in the past decades. However, limited research has been done to interpret non-speech body sounds. Therefore, in this work, we include a standard set of acoustic features used in human speech analysis and a number of other features that have been demonstrated to perform well in capturing paralinguistic features of vocal sounds. Table 3 lists all the frame-level features and their corresponding acronyms. Specifically, the frame-level features include 8 sub-band power features, RMS energy, zero crossing rate (ZCR), 9 spectral features, 12 Mel Frequency Cepstral Coefficients (MFCCs). Let us consider that the sampling frequency is fₛ (8000 hz). Now for extracting the 8 log subband power features, we divide the spectrum into 8 subbands respectively having the following frequency ranges (0, fₛ/256), (fₛ/256, fₛ/128), (fₛ/128, fₛ/64), (fₛ/64, fₛ/32), (fₛ/32, fₛ/16), (fₛ/16, fₛ/8), (fₛ/8, fₛ/4), (fₛ/4, fₛ/2). The first sub-band power represents the total power in a very small frequency region from 0 to 31.25 Hz. From the second sub-band, the bandwidth of each sub-band is twice as much as that of the former sub-band. The logarithm (base 10) is applied to represent the power of each sub-band in a bel scale. The spectral features are used to characterize different aspects of spectra including the ‘center of mass’ (spectral centroid), ‘change of spectra’ (spectral flux), ‘variance of the frequency’ (spectral variance), ‘skewness of the spectral distribution’ (spectral skewness), ‘the shape of spectra’ (spectral slope, spectral rolloffs) etc. Lastly, MFCC coefficients capture the Cepstral coefficients using the source vocal tract model in speech signal processing.

TABLE 3
A list of frame-level features

| Group | Frame level descriptors | Acronym |
|---|---|---|
| Energy | log power of 8 subbands | LogSubband[i] |
| | Total RMS Energy | RMSenergy |
| Spectral | Spectral Centroid | SpectCent |
| | Spectral Flux | SpectFlux |
| | Spectral Variance | SpectVar |
| | Spectral Skewness | SpectSkew |
| | Spectral Kurtosis | SpectKurt |
| | Spectral Slope | SpectSlope |
| | Spectral Rolloff 25% | SpectROff25 |
| | Spectral Rolloff 50% | SpectROff50 |
| | Spectral Rolloff 75% | SpectROff75 |
| | Spectral Rolloff 90% | SpectROff90 |
| Crossing Rate | Zero Crossing Rate | ZCR |
| MFCC | 12 Mel Frequency Cepstral Coefficients | mfcc[i] |

TABLE 4
A list of statistical functions applied to the frame-level features for
extracting window-level features

| Type | Statistical Functions | Acronym |
|---|---|---|
| Extremes | Minimum | min |
| | Maximum | max |
| Average | Mean | mean |
| | Root Mean Square | RMS |
| | Median | median |
| Quartiles | 1st and 3rd Quartile | qrtl1, qrtl3 |
| | Interquartile Range | iqrl |
| Moments | Standard Deviation | std |
| | Skewness | skew |
| | Kurtosis | kurt |
| Peaks | Number of peaks | numOfPeaks |
| | Mean Distance of Peaks | meanDistPeaks |
| | Mean Amplitude of Peaks | meanAmpPeaks |
| Rate of Change | Mean Crossing Rate | mcr |
| Shape | Linear Regression Slope | slope |

Based on those extracted frame-level features, we grouped frames into windows with much longer duration and extract features at the window-level. We considered the window length in the range of 1 s-5 s, also determined empirically based on the classification performance. To extract window-level features, we applied a set of statistical functions across all the frame-level features within each window. Table 4 lists all the statistical functions applied to the frame-level features within the window to capture different aspect of the frame-level features. Specifically, the window-level features capture the averages, extremes, rate of change, and shape of the frame-level features within each window. For example, one window-level feature is the mean value of the zero crossing rates (ZCR) in frames, which is measured by at first estimating the ZCR of individual frames and then calculating the arithmetic mean value across all the ZCRs in a particular window. In total, we extracted 512 window-level features.

### 4.3 Feature Selection

The two-step feature extraction in the last section generates a total of 512 features. Since we are going to implement the overall feature extraction and classification framework on resource limited smartphone and wearable platform, it is not computationally efficient to include all these features. Therefore, the goal is to select a minimum number of features that achieve reasonably good classification performance. In our work, we use the correlation feature selection (CFS) algorithm to select the subset of features (Hall, M. A. Correlation-based Feature Selection for Machine Learning. PhD Thesis (April 1999)). In general, the CFS algorithm evaluates the goodness of features based on two criteria. First, the feature is highly indicative of the target class. Second, the new feature select must be highly uncorrelated with the features already selected. We used CFS algorithm to select a set of 30 features.

From these 30 features we further select the most optimized feature set for the target classifier. To do this, we run a sequential forward feature selection algorithm with the classifier's performance as criteria to select the top N best features. As a classifier Linear Discriminative Classifier is used, which will be explained in further detail in Section 4.4. The best features selected includes logSubband std, logSubband median, specQrt125 min, logSubband std, logSubband qrt175, logSubband numOfPeaks, ZCR std, logSubband std, logSubband mean, specRoff50 meanCrossingRate, and logSubband median.

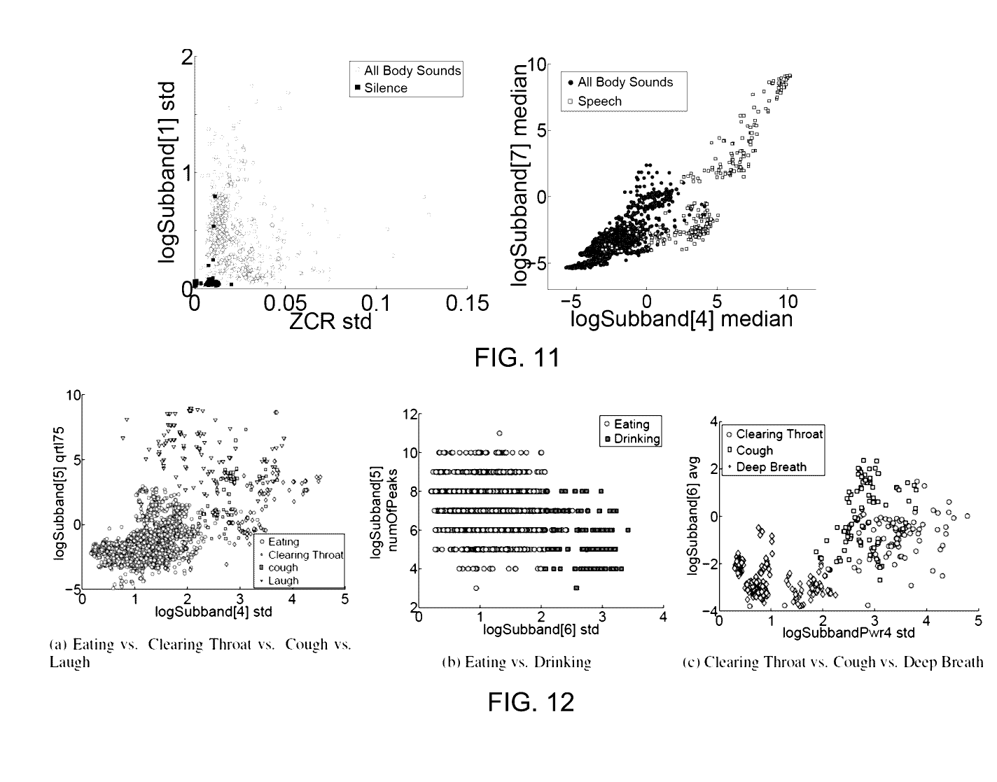

To show the performance of these selected features, a series of scatter plots in 2D feature space are shown in FIGS. 11 and 12. First, FIG. 11a shows the scatter plot of silence and all the body sound classes with respect to the two features: the standard deviation of zero crossing rate and the log of first sub-band power (logSubband std). Silence typically consisted of low energy random signal. The signal's zero crossing rate and the logSubband does not vary much across frames. Thus, using these two features, we can discriminate all body sounds from silence. FIG. 11b shows speech and all the body sounds in the feature space of logSubband median and logSubband median. As illustrated, speech signals contain much higher power in both of the sub-bands. Thus, using these two features, we can discriminate speech from all the body sounds considered for this study.

FIG. 12 shows the difference among different body sounds in different pairs of selected features. FIG. 12a indicates that eating sounds are fairly different from cough, laughter, and clearing the throat in the 2 dimensional feature space of logSubband std and logSubband qrt175. Both of the features have the low values for eating sounds. The 5th sub-band laughter contains slightly higher energy than others. FIG. 12b shows that the most discriminative feature for separating eating from drinking is logSubband std. It means that the 6th sub-band's log energy varies more for the drinking sound than that of eating sounds. FIG. 12c shows that deep breathing sounds contain lower energy in 6th sub-band. The standard deviation of the 4th sub-band's log energy also varies much less for deep breathing sounds compared to cough and clearing throat.

### 4.4 Classification

We use Linear Discriminant Classifier (LDC) as the classification algorithm. We chose LDC over other classification algorithms such as Support Vector Machine (SVM), Gaussian Mixture Model (GMM) and Adaboost because LDC is also computationally efficient and lightweight enough to be implemented in resource-limited smartphone. Table 5 shows the results of different classifiers with different feature sets. We used two different cross-validation experiments: a Leave-One-Person-Out (LOPO) and a Leave-One-Sample-Out (LOSO) cross-validation experiment. The LOPO cross-validation results are the most unbiased estimate of our classifier's performance, when the classifier is asked to detect the body sounds of a new person that the classifier has not seen before. In contrast, the LOSO cross-validation assumes that the classifier is trained on the data collected from the target user. The performance results from the LOSO cross-validation can be thought as the ceiling performance of the system. The best performance is achieved using LDC and energy, spectral features, and MFCC is used to extract the initial set of window-level features for selecting the top window-level features. The performance reaches to 72.5 (average recall) and 63.4 (precision).

Table 5 also shows that with only energy and spectral features as frame-level features, the LDC classifier can get a nice performance, which is 71.2 (recall), 61.5 (precision), and 66.5 (accuracy) from the LOPO experiment. Moreover, if a user contributes some training data towards making the classifier, the performance measure reaches to 88.1% recall (from LOSO experiment). Notice that losing MFCC from our frame-level feature set does not affect the classifier's performance much (absolute reduction in terms of recall is 1.3%), but if we don't have to extract MFCC features, that indicates that we could save a lot of system's resource in terms of power, speed, and memory. Considering this factor, we decided to use just energy and spectral features as frame-level features with LDC as classifier for the rest of our analysis and system implementation. Lastly, we also build the classification algorithm used by a recent study to compare with our proposed BodyBeat classification algorithm. We find that our system outperforms BodyScope. Lastly, table 6 shows the class level recall and precision from the LOPO experiment this classifier.

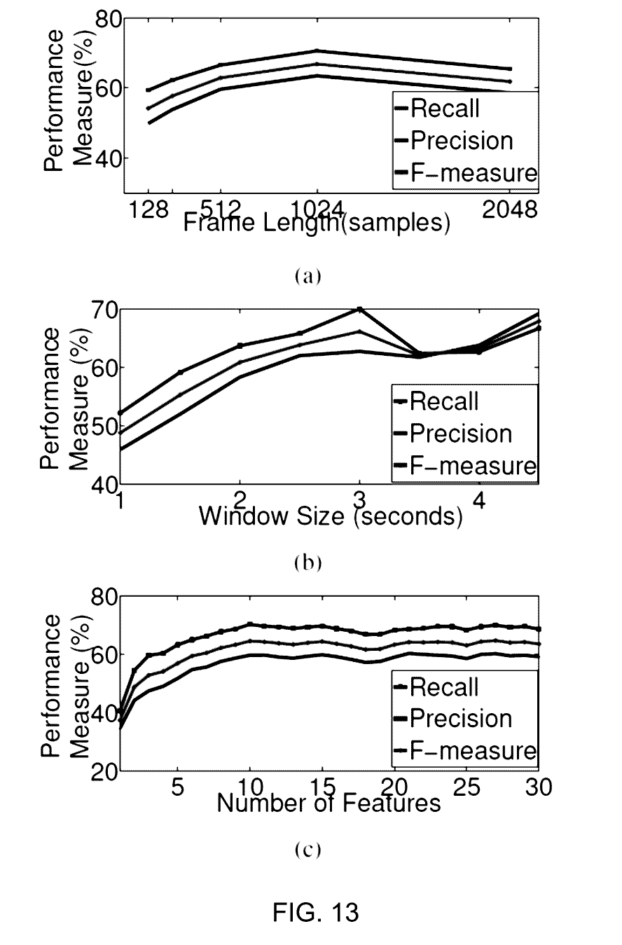

The choice of both the frame and window size length used to extract features significantly impacts classification performance. A coarse frame or window size may not capture the local dynamic (time variant) properties of the body sounds. On the other hand a very fine frame or window may be prone to noise and thus may decrease the discriminative properties of the features. We run this analysis to find the optimal frame and window size. FIGS. 13a and 13b shows the impact of the frame and window size on the classifier's performance. The frame size of 1024 samples (125 milliseconds) and the window size of 3 seconds maximize the classifier's performance. The number of features selected using the feature selection also plays a very important role on the performance measure of the classifier. FIG. 13c shows that the performance measures in terms of recall, precision and F-measure saturates when we use 10 window-level features.

### 5. SYSTEM IMPLEMENTATION

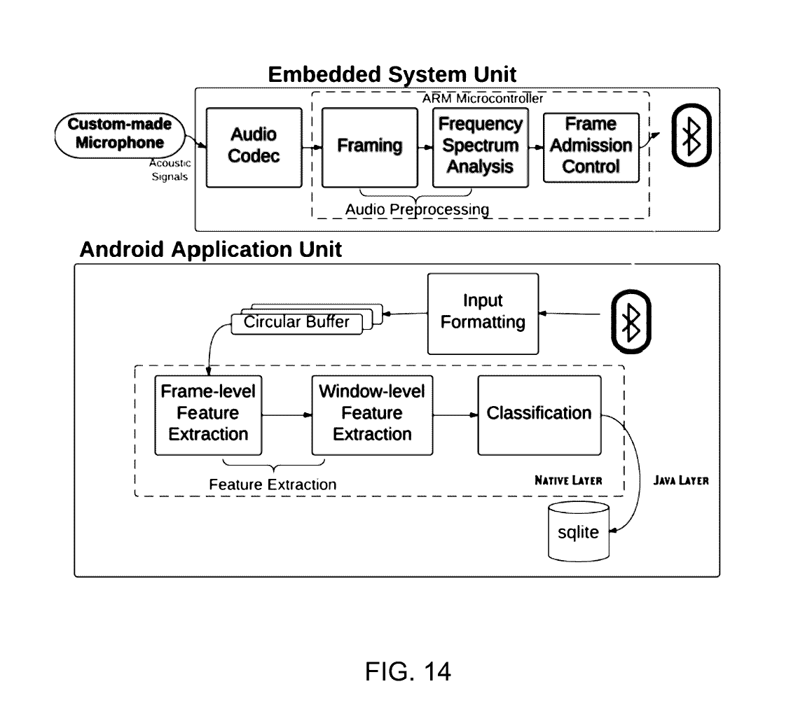

The BodyBeat non-speech body sound sensing mobile system is implemented using an embedded system unit and an Android application unit. The custom-made microphone of BodyBeat system is directly attached to the embedded system. The embedded system unit utilizes an ARM microcontroller unit, an audio codec and a Bluetooth module to implement capture, preprocessing and frame admission control of the raw acoustic data from the microphone. The Android application unit on the other hand implements the two stage feature extraction, and inference algorithm. These two units communicate with each other through Bluetooth. FIG. 14 illustrates the system architecture of the overall system. In what follows, we present the system implementation details of both the embedded system unit and the Android application unit.

TABLE 5
Classification performance in terms of Recall (R), Precision (P) and F-
measure (F) based on both Leave-One-Person-Out (LOPO) and a
Leave-One-Sample-Out (LOSO) cross-validation

| | LOPO | | | LOSO | | |
|---|---|---|---|---|---|---|
| Frame-level Features | R | P | F | R | P | F |
| Energy & Spectral | 71.2 | 61.5 | 66.5 | 88.1 | 81.9 | 86.5 |
| MFCC | 66.3 | 52.8 | 57.8 | 75.0 | 71.5 | 73.2 |
| Energy & Spectral & MFCC | 72.5 | 63.4 | 67.6 | 90.3 | 82.3 | 86.6 |
| BodyScope | 57.6 | 55.5 | 56.5 | 76.6 | 71.5 | 73.8 |

TABLE 6
The Recall and Precision for each class from the LOPO experiment using
LDC as classifier and energy and spectral features as frame-level features

| | Eating | Drinking | Deep Breathing | Clearing Throat | Coughing | Sniffling | Laugh | Silence | Speech |
|---|---|---|---|---|---|---|---|---|---|
| Recall | 70.35 | 72.09 | 64.09 | 68.75 | 80.00 | 75.00 | 61.90 | 74.38 | 81.06 |
| Precision | 73.29 | 57.21 | 60.95 | 61.11 | 62.07 | 58.00 | 61.90 | 61.66 | 84.69 |

### 5.1 Embedded System Unit

At the center of the embedded system unit, we used a commercially available Maple ARM microcontroller. The board consists of a 72 MHz ARM cortex M3 chip with most of the standard peripherals including digital and analog input/output pins, 1 USB, and 3 Universal Asynchronous Receiver/Transmitters (UARTs), and Serial Peripheral Interface (SPI). The clock speed, advanced peripherals, and interrupt capabilities enables us to do some rudimentary real-time audio signal processing and at the same time to drive a Bluetooth modem to communicate with the Android application unit.

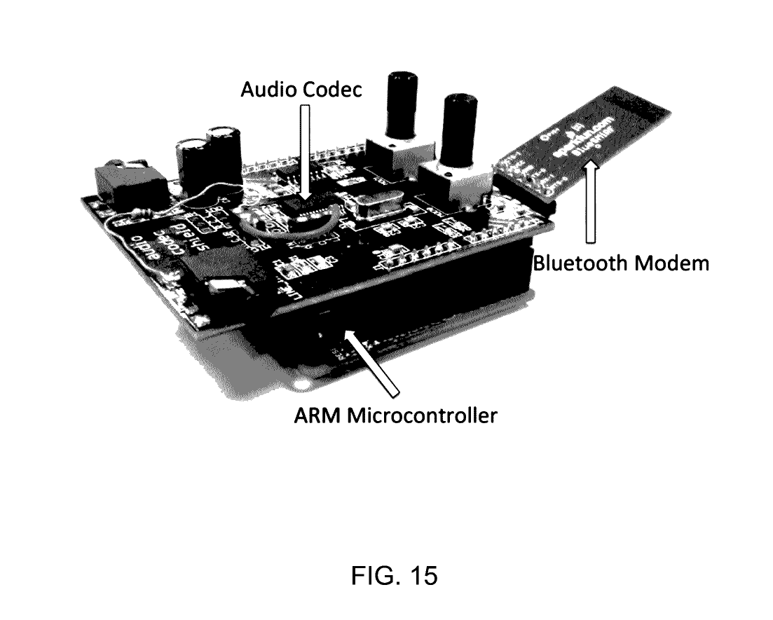

As seen in FIG. 14, the ARM microcontroller connects to an audio codec via SPI. The audio codec contains a Wolfson WM8731 chip. The audio codec receives the analog audio signal using a ⅛ inch input jack and samples the audio with an array sampling frequency up to 88000 Hz and with a resolution up to 24 bit/sample. The ARM unit is also connected with a class 2 Bluetooth ratio modem (commercially called BlueSMiRF Silver). The Bluetooth modem contains the RN-42 chip that receives data from the ARM unit via UART and sends data to the Android application with an SPP profile with a data rate of 115000 bps. The Bluetooth modem ensures reliable wireless connectivity with the Android device up to a distance of 18 meters. A rechargeable LiPo battery is used to power the ARM microcontroller, including the audio codec and Bluetooth modem. FIG. 15 shows the prototype of embedded unit.

### 5.1.1 Audio Preprocessing

Audio preprocessing is the first step that happens in the ARM microcontroller, which receives the digital samples of the BodyBeat microphone's analog audio stream by the Audio Codec. The sampling frequency and bit resolution are chosen to be 8000 Hz and 16 bit, respectively, as it provides us with a detailed picture of the audio and lowers the computational load of the system at the same time. As the Audio Codec samples the analog audio signal and sends a digital signal to the ARM microcontroller unit via SPI, the interrupt in the ARM microcontroller unit collects the data in a circular buffer. The audio data stored in the circular buffer is then segmented with a frame length of 1024 samples (125 milliseconds). While the interrupt fills the circular buffer, the main thread essentially checks continuously if another 1024 samples has filled the circular buffer. Upon detecting the arrival of a new frame, the ARM unit stars a RADIX-4 Complex Fast Fourier Transformation (FFT) implementation, which is written in C language. The FFT implementation uses fixed-point arithmetic with a sine table for optimizing speed by sacrificing some memory. To prevent an arithmetic overflow, fixed scaling is employed.

### 5.1.2 Frame Admission Control

The ARM microcontroller also does a frame admission control to filter out audio frames that do not contain any body sounds. After getting the FFT of the Hanning windowed audio frame of 1024 samples, we extracted a few important sub-band power and zero crossing rate features to detect the presence of speech and silence. In FIG. 11, we already demonstrated how with a few features we can filter out frames containing silence and speech. We took a few measures to optimize our implementation in this regard. For example, one of the features that we implemented in our ARM microcontroller is logSubband median. Floating point logarithm calculation is heavy in terms of both CPU. We used a log table to lower the CPU requirements by sacrificing some memory. When a certain frame is detected not to contain any silence or speech, the ARM microcontroller transfers the power spectrum of the current frame to the Android unit. To asynchronously transfer different frames, we send a preamble to mark the start of a frame.

### 5.2 Android Application Unit

The Android application unit, which is approximately 2200 lines of Java, C, and C++ code, includes the input formatting of the data, which is followed by feature extraction and classification. The android unit implements a feature extraction and classification algorithm in the native layer using C and C++ for faster execution. The complete binary package including resource files is approximately 1280 KB.

### 5.2.1 Input Formatting

The Android unit receives data via Bluetooth from the embedded system unit as shown in FIG. 14. This module used the Android Bluetooth APIs to scan for other Bluetooth devices around the phone, to fetch the information of the paired (or already authenticated) remote Bluetooth modem in the embedded system unit, and to establish wireless communication channel. The Android application receives each frame asynchronously from the embedded unit. The Android Bluetooth adapter continuously looks for a four byte long preamble, which indicates the start of a new frame is being sent by the embedded system unit. Upon receiving the preamble, the input processing module continuously stores all the received data in a temporary buffer. As soon as the temporary buffer is full (received 513 samples, each 16 bit), the input processing module takes all the data of the current frame from the temporary buffer and updates a two dimensional circular buffer. At the same time, the input processing unit starts to look for another preamble indicating the start of another frame. This preamble helps the Android application unit to receive each frame of data separately. The two dimensional circular buffer is shared by both the producer thread and the consumer thread as data storage and data source. The two dimensional circular buffer stores each frame's data (513 samples) in a row. Thus, consecutive frame data is stored in different rows in the two-dimensional circular buffer. All the work in input processing happens in producer thread. To facilitate the two dimensional circular buffer sharing by the two threads, it includes two separate pointers for the two threads (producer and consumer) at different rows of the two dimensional circular buffer.

### 5.2.2 Feature Extraction and Classification

Once the two dimensional circular buffer contains 24 frames of data (window length 3 seconds) for the feature extraction and inference, the consumer thread passes the data to the native layer. To ensure 50% overlap between two consecutive windows, the consumer thread's pointer moves to 16 rows to point to the new frame. The entire feature extraction and classification algorithm is implemented in the native layer considering the speed requirements for real-time passive body sound sensing. Section 4 gives the detailed description of the discriminative features for body sound classification. The frame-level features are first extracted from frame-level data. We used various statistical functions to extract window-level features at this stage. The window-level features are then used to infer the body sound. While implementing the feature extraction and classification, we took several measures to optimize power, CPU, and memory usage. We used additional memory for lowering CPU load. All the memory blocks are pre-allocated during the initialization of the Android application unit and are shared across multiple native layer calls.

### 5.3 System Evaluation

In this section, we present the system evaluation of the BodyBeat system. We first discuss CPU and memory benchmarks, which is then followed by the detailed time and power benchmarks, including both the embedded system unit and the Android application unit. All the measurement of the Android application unit is done with Google Nexus 4.

### 5.3.1 CPU and Memory Benchmarks

TABLE 7
CPU and Memory Benchmarks of the Android Application Unit

| Status | CPU Usage | Memory Usage |
|---|---|---|
| Silence or speech | 8-12% | 45 MB |
| Body Sound | 15-22% | 47 MB |

Table 7 shows the CPU and memory benchmarks of our system. When the BodyBeat microphone captures either silence or speech, the Android application unit consumes less than 12% of the CPU and 45 MB of memory, because of embedded system's frame admission control. During the presence of body sounds, the CPU and memory usage increases and reaches up to 22% and 47 MB.

### 5.3.2 Time and Power Benchmarks

FIG. 8 shows the average running time of different routines in both the embedded system unit and Android application unit for processing 3 seconds of audio from the BodyBeat microphone that contains some body sound. In the embedded unit, the first routine forms a frame of 1024 samples and multiplies it with the Hanning windowing function to compensate Gibbs phenomena. The framing only takes 5 milliseconds where the next process Fast Fourier Transformation (FFT) takes 80 milliseconds. The frame admission control takes up to 20 milliseconds.

The input processing in the Android application unit takes the most of the time, as it includes the delay due to Bluetooth communication. The feature extraction passes each frame (power spectra received via Bluetooth, length 513 data) in the window to the native layer to extract frame-level features. The frame-level feature extraction takes a moderate amount of time, as this is one of the most heavy routine in Android application unit. Lastly, the window-level feature and classification takes only 5 and 1.5 milliseconds to run.

TABLE 8
Average running time of different routines in the ARM microcontroller
unit and the Android application unit to process 3 seconds (one
window) of audio data containing some body sound

| Unit | Routine | Time (ms) |
|---|---|---|
| Embedded | Framing | 5 |
| | FFT | 80 |
| | Frame admission control | 20 |
| Android | Input Processing | 2448 |
| | Frame-level feature extraction | 84 |
| | Window-level feature extraction | 5 |
| | Classification | 1.5 |

TABLE 9
The Power benchmarking of Android app unit

| Routine | Average Power (milliWatt) |
|---|---|
| Input Processing (IP) | 343.74 |
| IP & Feature Extraction (FE) | 362.84 |
| IP & FE & Classification | 374.49 |

The embedded system unit consumes 256.64 milliwatt (mW) when the system is waiting to be paired and connected with an Android system. The embedded system unit consumes about 333.3 mW power while the raw audio data contains valuable body sounds and the frame admission control allows the data to be transferred to the Android system unit. On the other hand, when frame admission control detects either silence or speech in the signal and stops transmission of the data to Android unit, the embedded system unit's power consumption decreases to 289.971 mW. Table 9 illustrates the average power (in milliwatt unit) consumed by different routines of the Android application unit. The average power consumption by the Android application unit is about 374.49 mW, when the application unit runs all the routines (input processing, frame- and window-level feature extraction and classification).

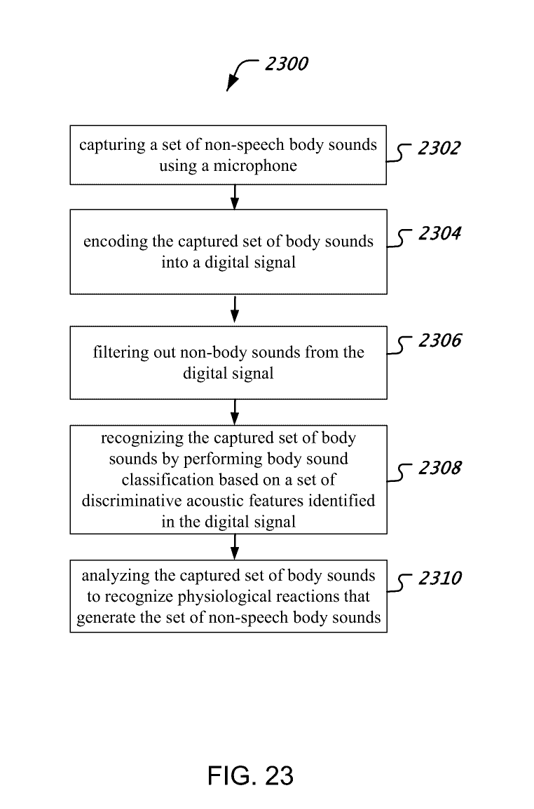

FIG. 23 shows an example of a method 2300 for sensing non-speech body sounds. The method 2300 may be implemented using the various equipment described in the present document.

At 2302, the method 2300 includes capturing a set of non-speech body sounds using a microphone while dampening external sounds and ambient noises. In some embodiments, the microphone includes a piezoelectric sensor-based microphone that captures body sounds conducted through body surface, such as the piezoelectric sensor-based microphone illustrated in FIG. 2.

At 2304, the method 2300 includes encoding the captured set of body sounds into a digital signal. In some embodiments, the encoding can be performed by, for example, the audio codec shown in FIG. 15.

At 2306, the method 2300 includes filtering out non-body sounds from the digital signal. In some embodiments. For example, the filtering operation can also be performed by the micro-controller shown in FIG. 15.

At 2308, the method 2300 includes recognizing the captured set of body sounds by performing body sound classification based on a set of discriminative acoustic features identified in the digital signal. In some embodiments, the set of discriminative acoustic features are identified to produce a set of extracted features using a two-step feature extraction procedure, including a frame-level feature extraction having a frame size and window-level feature extraction having a window size. The set of discriminative acoustic features are further identified by selecting a subset of features from the set of extracted features.

At 2310, the method 2300 includes analyzing the captured set of body sounds to recognize physiological reactions that generate the set of non-speech body sounds. In some embodiments, the method 2300 may include segmenting, prior to the recognizing, the digital signal into overlapping frames having a uniform length, for example, with a 50% overlap as described herein.

### 6. POTENTIAL APPLICATIONS

An increasing number of mobile systems are bringing health sensing to the masses. The disclosed mobile sensing system can sense a wide range of non-speech body sounds for a number of different applications. By listening to the internal sounds that our bodies naturally produce, the disclosed mobile sensing system can continuously sense many medical and behavioral problems in a wearable form factor. Some of applications that can be developed with the disclosed BodyBeat mobile sensor system include the following.

### 6.1 Food Journaling

Since BodyBeat can recognize eating and drinking sounds, it has the potential to be used in food journaling applications. Despite technological advancements, developing automatic (or semi-automatic) systems for food journaling is very challenging. For example, the PlateMate system demonstrated the feasibility of using Amazon Mechanical Turk to label photographs of users' meals with caloric information. However, this system required that users actually remember to take a photo of what they eat. With the invention of BodyBeat, you can imagine a future system that detects when a user is eating. The system then either automatically takes a picture of their food with a life-logging camera (e.g. Microsoft SenseCam, Google Glass), or simply reminds the user to take a photo of their food. Lastly, it uploads the image to Mechanical Turk for caloric labeling.

### 6.2 Illness Detection

In BodyBeat the acoustic sensor is embedded in a neckband to capture body vibrations from throat area, which contains a respiratory pathway (Trachea) and significant vein and artery. The high frequency vibrations generated from air or blood flows contain a lot of information about our pulmonary and cardiovascular health (e.g. wheezing noise or the whooshing and swishing sounds of a heart murmur). Similarly, the body vibrations generated by the mastication and swallowing processes, are indicative of our dietary behavior. Even body vibrations due to laughter and yawning can be good indicators of affect. Therefore, BodyBeat automatically tracks these body vibrations for different applications ranging from early detection of symptoms of different diseases, dietary monitoring, and affect sensing.

The BodyBeat system allows us to detect coughing, deep or heavy breathing, which can be indicative of many pulmonary diseases. While a few previous studies have illustrated success detecting these body sounds indicative of illness, BodyBeat mobile system can be used in an application which will detect the onset, frequency, and the location of coughing, heavy breathing or any other kind of pulmonary sounds. As sensing devices become more ubiquitous, cough detection could allow us to track the spread of illnesses, with similar motivation to TwitterHealth research. Some examples of medical applications for the BodyBeat system include detecting other body sounds of interest, such as sneezing and specific types of coughing (e.g., wheezing, dry cough, productive cough).

The capture and analysis of physiological acoustics has proven diagnostic merit. Physicians have been successfully using stethoscope for auscultation or listening to internal body vibrations for a long time to detect pulmonary and cardiovascular anomalies. Different abnormal lung and breathing sounds contain a lot of information about different chronic illnesses. For example, recent studies used cough, wheeze and shortness of breath to diagnose asthma. All of these sounds can be captured continuously and passively by BodyBeat. However, listening to these abnormal breathing and lung sounds is only done when there is a doctor-patient interaction. A mobile system that continuously and passively listens to these body vibrations and detects physiological anomalies could provide the patients and medical practitioners with a rich set of data when the users are away from the doctors. This continuous stream of rich data could be extremely valuable for early detection and monitoring of diseases.

### 7. ADDITIONAL APPLICATIONS

The microphone is a rich sensor stream that contains information about our surroundings and us. The disclosed mobile sensing system can include a customized microphone based on piezo-electric sensor that is optimized for subtle body sounds. A neckpiece can be included and designed with a consideration on the microphone's longer-term wearability and users' comfort. The neckpiece also employ a suspension mechanism to compensate friction noise due to user's body movement. Body sounds are a fundamental source of health information and are being used by physicians since almost the beginning of modern medical science. Due to the subtle nature of body sounds, it is difficult to reliably and passively capture body sound signals with a built-in smartphone microphone. As a result, some studied have explored the feasibility of a customized-wearable microphone for recognizing eating behaviors, breathing patterns, etc.

Disclosed are implementations of signal processing and machine learning algorithms in the context of a distributed system that includes an ARM micro-controller and a smartphone, such as an Android phone. The disclosed algorithms are compared to baseline algorithms, and the results from the CPU, memory, and power benchmarking experiments are presented.

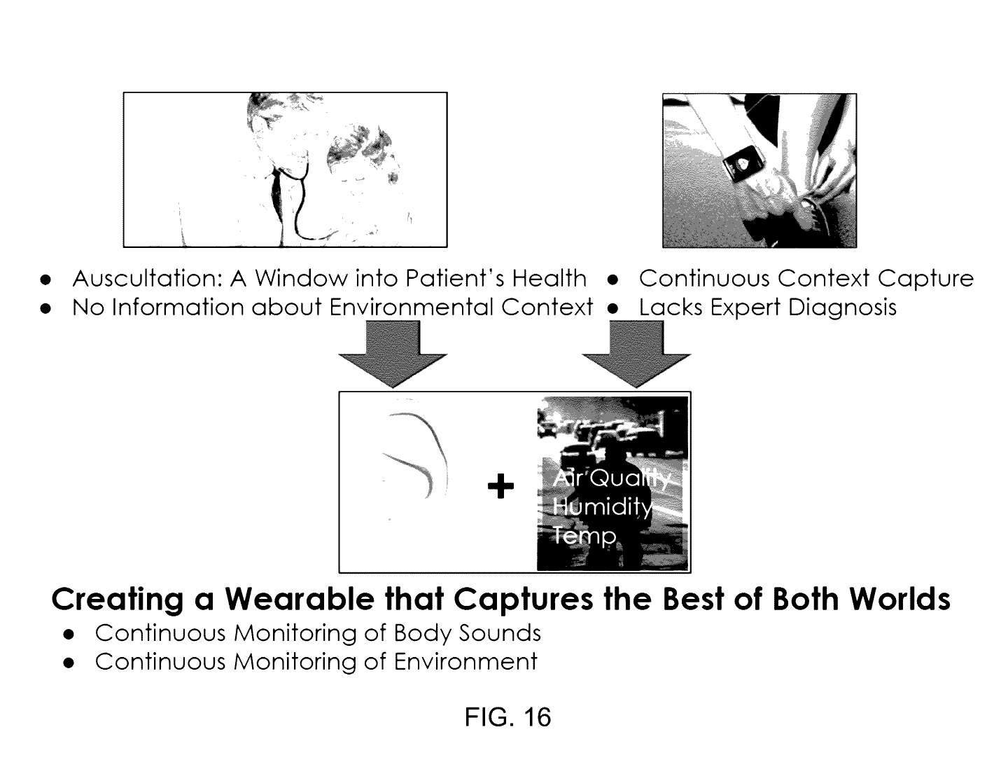

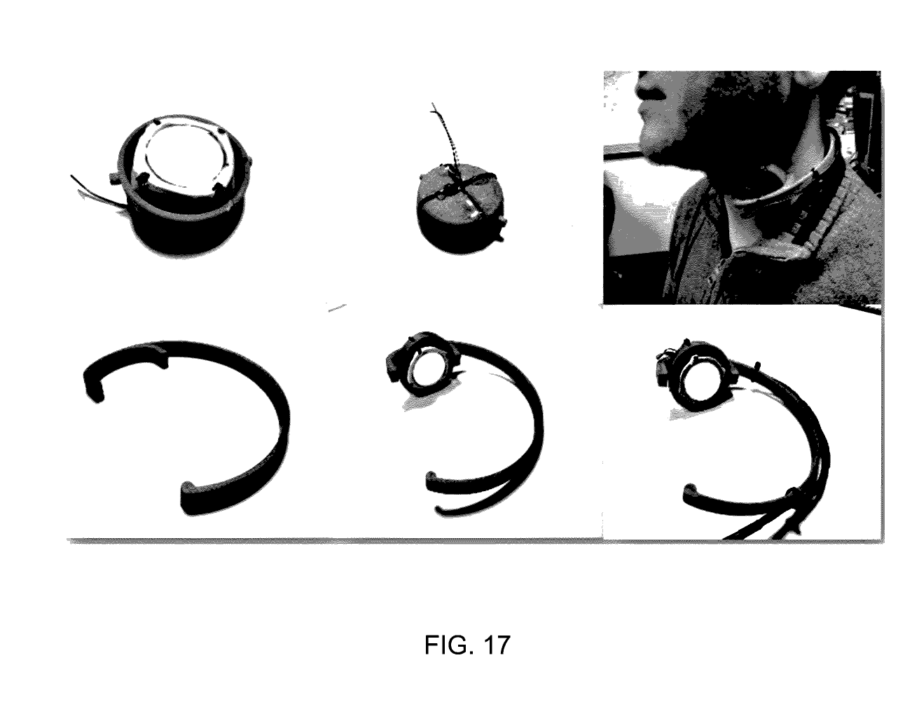

FIG. 16 is an illustration for various uses of a wearable that monitors body sounds and environment. For example, the wearable may provide a window into a patient's health, information about environmental context of the patient, provide a continuous context capture and help experts perform better diagnosis of a patient's condition due to continuous patient and environment monitoring.

FIG. 17 shows an example mobile sensing system to capture and analyze subtle body sounds. The microphone is located on one side, and may be placed around the voicebox/throat area with a curved and flexible strap that can hold the microphone in place.

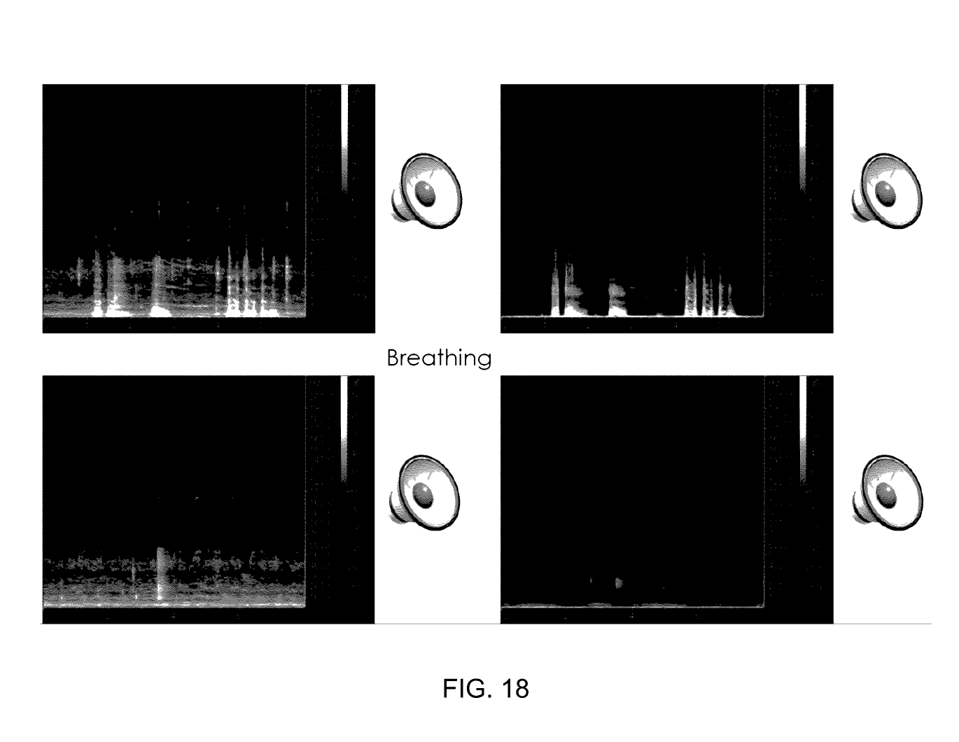

FIG. 18 shows example sound profiles illustrating advantages of disclosed mobile sensing system.

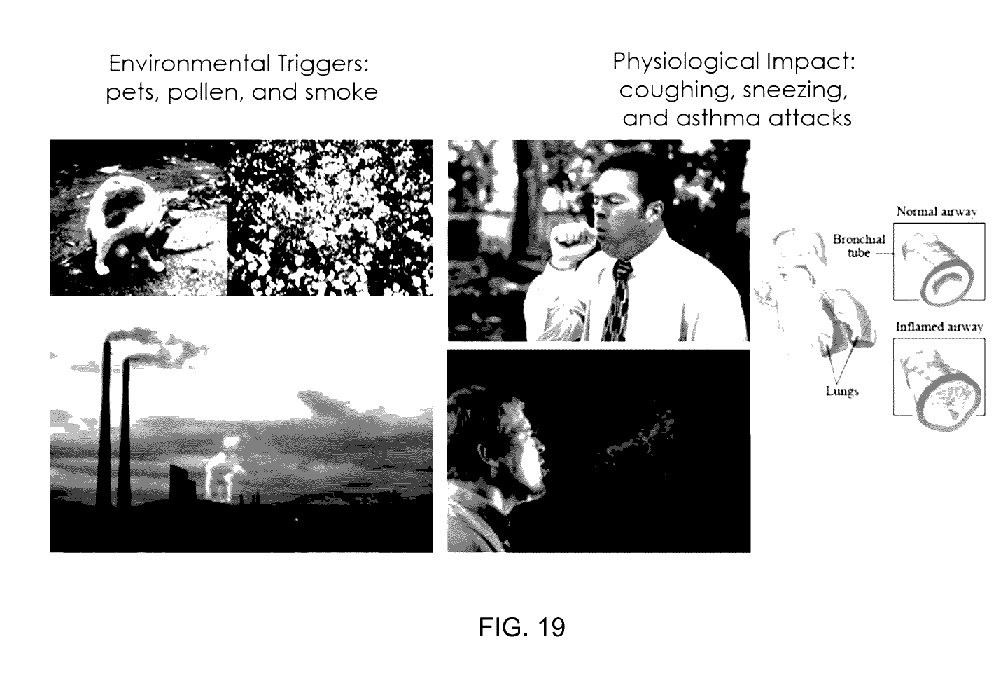

FIG. 19 shows how an environment can affect our bodies. For example, environmental triggers such as pets, pollens and smoke can have physiological impact on a person including coughing, sneezing and asthma attacks.

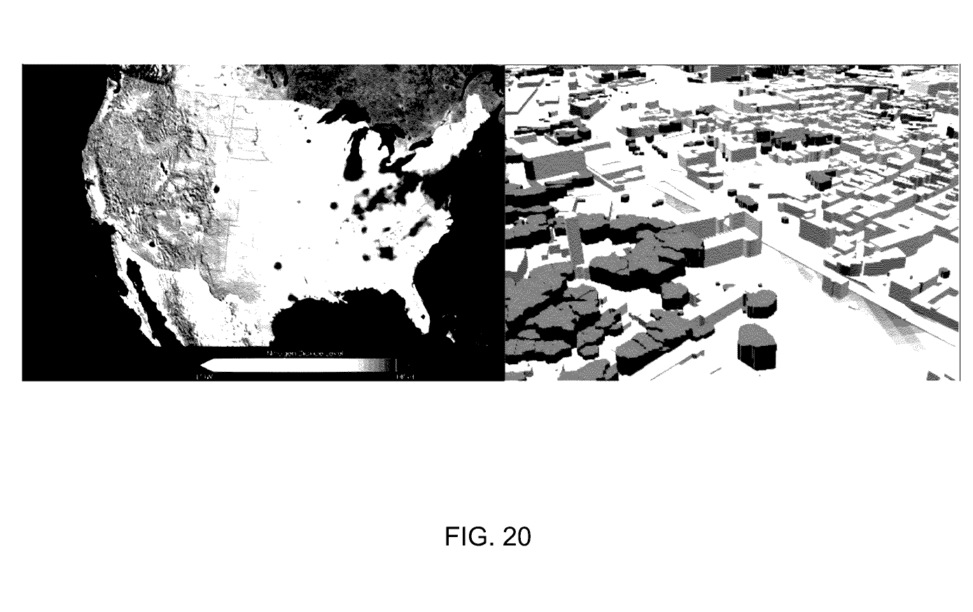

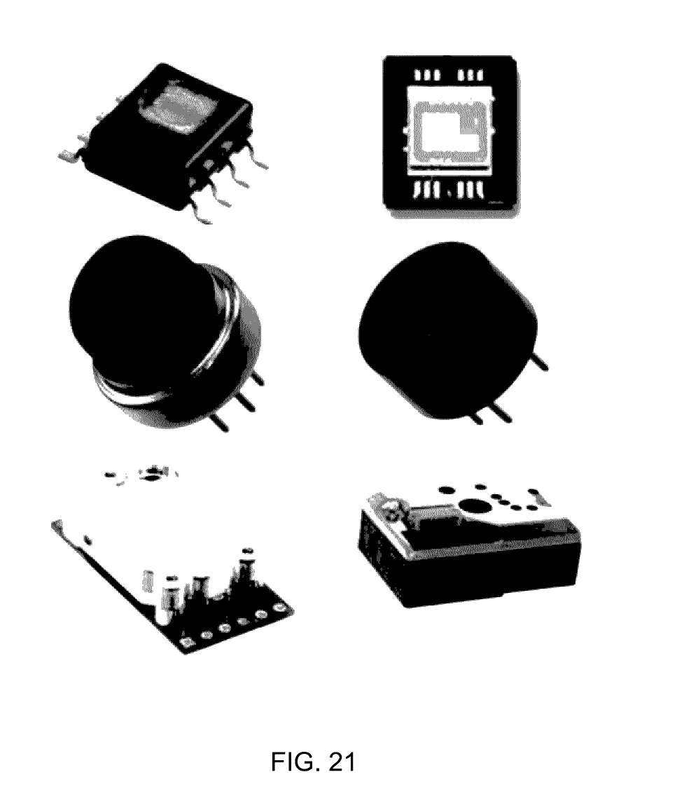

FIG. 20 shows how much environmental context, such as air quality can change on both macro and micro level.

FIG. 21 shows example environmental sensors that can sense temperature, humidity, altitude, UV light, dust, oxygen, methane, CO₂, etc.

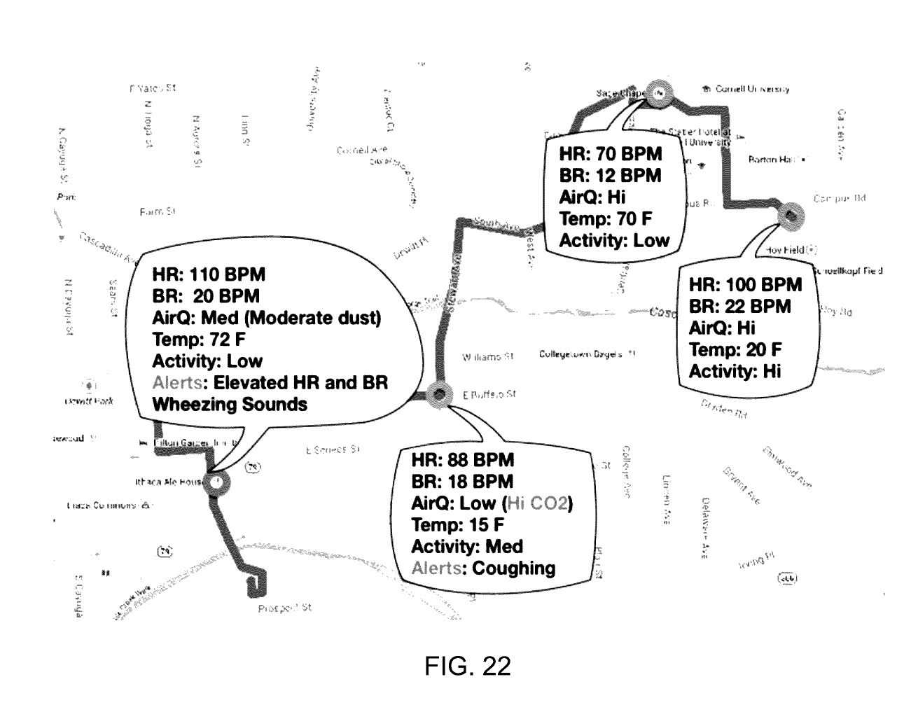

FIG. 22 shows an example system for remotely monitoring clinically vital sounds from multiple people in multiple locations, or a same patient in multiple locations. The monitoring results about heart rate (HR), breathing rate (BR) etc. may be tied into a map and presented graphically to a care giver who can continuously monitor the patient's condition.

### 8. CONCLUSION AND FUTURE WORK

This patent document includes the design, implementation and evaluation of BodyBeat, a wearable sensing system that captures and recognizes non-speech body sounds. The design of a custom-built piezoelectric sensor-based microphone has been described and showed that the disclosed microphone outperforms other existing solutions in capturing non-speech body sounds. In addition, a classification algorithm has been developed based on a set of carefully selected features and achieved an average classification average recall of 71.2%. In addition, the disclosed BodyBeat mobile sensor system has been benchmarked for its performance.

In some implementations, the form factor of BodyBeat can be reduced to improve its wearability and minimize its obtrusiveness to users. Also, the BodyBeat mobile sensing system can be implemented to detect other non-speech body sounds. In addition, non-speech body sounds can be processed at a lower sampling rate and run the end-to-end evaluation of the system.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

While certain embodiments have been described with specific values of member thickness, shore hardness, window size, etc., it is understood that implementations within a reasonable tolerance of these values (e.g., plus-minus 10 percent) could be used during practical implementations to take into account implementation differences. Only a few implementations and examples are described and other implementations, enhancements and variations can be made based on what is described and illustrated in this patent document.

What is claimed are techniques and structures as described and shown, including:

1. A mobile sensing system, comprising:
a microphone configured to capture a set of non-speech body sounds while dampening external sounds and ambient noises;
an audio codec module receiving an analog audio signal representing the captured set of body sounds from the microphone and converting the analog audio signal to a digital signal;
a micro-controller coupled to the audio codec module to filter out non-body sounds from the digital signal and preprocess the filtered digital signal into frame data; and
an audio processor receiving the frame data from the micro-controller, configured to recognize the captured set of body sounds by performing body sound classification based on a set of discriminative acoustic features identified in the frame data.

2. The mobile sensing system of claim 1, wherein the microphone includes a piezoelectric sensor-based microphone that captures body sounds conducted through body surface.

3. The mobile sensing system of claim 1, wherein the piezoelectric sensor-based microphone is highly sensitive to subtle body sounds and less sensitive to external ambient sounds or external noise.

4. The mobile sensing system of claim 1, further comprising a modem to establish wireless communication between the micro-controller and the audio processor for the audio processor to receive the frame data from the micro-controller.

5. The mobile sensing system of claim 1, wherein the micro-controller includes an ARM micro-controller.

6. The mobile sensing system of claim 1, wherein the audio processor is configured to recognize physiological reactions that generate the set of non-speech body sounds.

7. The mobile sensing system of claim 1, wherein the audio processor is located in a mobile device.

8. The mobile sensing system of claim 1, wherein the audio processor is coupled to the micro-controller via a wireless network connection.

9. A method for sensing non-speech body sounds, comprising:
capturing a set of non-speech body sounds using a microphone while dampening external sounds and ambient noises;
encoding the captured set of body sounds into a digital signal;
filtering out non-body sounds from the digital signal;
recognizing the captured set of body sounds by performing body sound classification based on a set of discriminative acoustic features identified in the digital signal; and
analyzing the captured set of body sounds to recognize physiological reactions that generate the set of non-speech body sounds.

10. The method of claim 9, wherein the microphone includes a piezoelectric sensor-based microphone that captures body sounds conducted through body surface.

11. The method of claim 9, wherein the set of discriminative acoustic features are identified to produce a set of extracted features using a two-step feature extraction procedure, including a frame-level feature extraction having a frame size and window-level feature extraction having a window size.

12. The method of claim 11, wherein the set of discriminative acoustic features are further identified by selecting a subset of features from the set of extracted features.

13. The method of claim 9, further including segmenting, prior to the recognizing, the digital signal into overlapping frames having a uniform length.

14. A microphone, comprising:
a capsule filled with an internal acoustic isolation material;
a diaphragm placeable on skin of a human body;
a sensor placed in the capsule, wherein a first side of the sensor is in contact with the internal acoustic isolation material and a second side of the sensor is covered by the diaphragm; and
an external acoustic isolation material enclosing the capsule and the diaphragm and capable of reducing external noise.

15. The microphone of claim 14, wherein the capsule comprises a plastic material and/or a polymer.

16. The microphone of claim 14, wherein the capsule is fabricated using three-dimensional printing or injection molding.

17. The microphone of claim 14, wherein the internal acoustic isolation material comprises a soft silicone with shore hardness between 10 OO and 20 A.

18. The microphone of claim 14, wherein the diaphragm has a thickness of less than 0.002 mm.

19. The microphone of claim 14, wherein the diaphragm is made of silicone or latex.

20. The microphone of claim 14, wherein the diaphragm has similar acoustic speed, dampening and propagation properties as that of human muscle and skin.

21. The microphone of claim 14, wherein the external acoustic isolation material comprises a hard silicone with shore hardness between 40 A to 80 A.

22. The microphone of claim 14, wherein the sensor comprises a brass piezoelectric sensor.
